(19) United States
(12) Patent Application Publication
(10) Pub. No.: US 2026/0236544 A1
(43) Pub. Date: Aug. 13, 2026

(54) Using Large Language Models for Dialogue Management and Recommendations in a Conversational Recommender System

(71) Applicant: Google LLC, Mountain View, CA (US)

(72) Inventors: Zhenning Tan, Union City, CA (US); Luke Beck Friedman, Mountain View, CA (US); Manoj Tiwari, Mountain View, CA (US); Sameer Ahuja, Mountain View, CA (US)

(21) Appl. No.: 19/151,837

(22) PCT Filed: Feb. 10, 2023
(86) PCT No.: PCT/US2023/012758

§ 371 Date: Jul. 29, 2025

(51) Int. Cl. G06F 16/9535; G06F 16/3329

(52) U.S. Cl. CPC G06F 16/9535; G06F 16/3329

(57) ABSTRACT

The technology relates to conversational recommender systems (100) that employ a large language model (402) which can function as part of a dialogue manager (326). This can include receiving, by one or more processors implementing a conversational recommender system, user input via a client device during an interactive conversation (1502), then predicting, by the one or more processors, a dialogue state from the received user input according to a trained large language model (1504). The process may include generating a response to the received user input based on the predicted dialogue state and identifying a set of relevant items from a candidate corpus (1506). The process may also include generating a recommendation slate comprising one or more of the relevant items from the set (1510), and then optionally presenting the recommendation slate and an explanation about the recommendation slate to a user of the client device along with the response to the received user input (1512).

### BACKGROUND

Recommender systems can be used to automatically provide information to users in a variety of applications, including on-line searching, video and news recommendations, shopping, and the like. Personalized recommender systems can deliver relevant content by inferring the preferences of a user and connecting them to a corpus of items. Machine learning algorithms employed in deep learning-based systems have capitalized on the abundance of user interaction data available to learn sophisticated statistical correlations and better optimize for key engagement metrics. However, despite the success of machine learning in this setting, the increasing reliance on implicit interaction signals such as clicks as a proxy for user preference has its downsides as well. Recommender systems may suffer from problems like surfacing clickbait, propagating societal biases and polarization of the user base. Such systems based on point-and-click interfaces may also afford the user only a low-bandwidth channel to communicate with the system and little chance to engage in any type of interactive exploration. Moreover, large-scale recommender systems intended to support many users can suffer from various drawbacks. One such drawback is a lack of transparency while offering limited opportunity for users to exercise control over their recommendations and engage in exploration over a sequence of interactions. Another is single-shot searching, or an inability to support continued interaction when searching. Yet another drawback is the difficulty in handling broad user queries that may not clearly specify what the user is looking get information about.

Certain conversational recommender systems (CRS) may provide the user a real-time way to communicate with the system and make it less reliant on implicit interaction signals such as clicks to infer preferences. The advent of large language models (LLMs) has enabled machine learning models to converse more naturally with humans and to exhibit signs of common-sense reasoning. This enables new opportunities for conversational recommender systems such as flexible dialogue, natural language explanations for recommendations and reasoning over user preferences. However, technical challenges exist, including dialogue control and bridging the gap between the conversational user interface and the underlying recommendation engine. For instance, LLMs can be prone to hallucinations and grounding them can be problematic. Hallucinations occur when the LLM derives something that is not true (e.g., “pigs can fly”) and asserts it as a fact. Also, one of the appeals of LLMs is their sense of naturalness and unpredictability, but when operating in a task-oriented setting this can mean that controlling an LLM can be more difficult than with a template-based system. Particularly challenging in the recommendation setting is how to interface between the LLM and the underlying recommendation engine.

### BRIEF SUMMARY

The technology relates to conversational recommender systems that employ a large language model which can function as part of a dialogue manager. This provides a technical benefit to the system with more efficient and effective analysis and processing. It also gives users the ability to refine their interests (thus, controllability) through multi-turn conversations, where each turn can include either an utterance (e.g., a query or statement) by a user, or interaction by the system (e.g., a natural language understanding-based query or response, a slate of recommendations, or both). The approaches described herein allow the system to explore and address user interest and provide transparency on the signals related to user profile information that may be relied on in order to present relevant recommendations.

The following presents the various system components of a conversational recommender system and the ways in which LLMs can be utilized in the system to provide unique advantages. By leveraging LLMs effectively, a controllable and explainable conversational recommender system is achievable over a huge corpus of millions or billions of items (e.g., video and/or audio content, web pages, etc.), without needing to collect large amounts of data from an existing conversational recommender product. Various examples are presented with illustrative conversations that show the fluency and diverse functionality of the system.

Aspects of the technology utilizing an LLM can be employed to directly reason about how well an item matches the context of a conversation within a ranking module and also generate an intuitive natural language explanation as a byproduct. Other possible use cases include dialogue management, incorporating natural language user profiles, and building realistic user simulators to generate synthetic data at scale for evaluation and tuning of system components.

According to one aspect, a conversational recommender system is implemented by one or more processors of a computer system. The conversational recommender system comprises a dialogue manager module having a trained large language model, and a recommendation engine in operative communication with the dialogue manager. The dialogue manager is configured to: receive user input via a client device during an interactive conversation; predict a dialogue state from the received user input according to the trained large language model; and generate a response to the received user input based on the predicted dialogue state. The recommendation engine is configured to: receive a query from the dialogue manager according to the predicted dialogue state; and identify a set of relevant items from a candidate corpus; generate a recommendation slate comprising one or more of the relevant items from the set. The dialogue manager is further configured to present the recommendation slate and an explanation about the recommendation slate to a user of the client device along with the response to the received user input.

In one example, the dialogue manager module is configured to predict the dialogue state based on the received user input and stored profile information associated with the user. Here, the stored profile information may be updatable by the conversational recommender system according to information provided by the user during the interactive conversation. The stored profile information may be editable by the user.

Alternatively or additionally, the dialogue manager module is configured to either predict the dialogue state or generate the response according to generation of a sequence of natural language outputs that encapsulate all context tracking and any intermediate reasoning during the interactive conversation.

In any of the scenarios herein, the large language model may be an encoder-based model configured to generate the response. By way of example, the encoder-based model may include a first encoder configured to process a target response for the interactive conversation and a second encoder configured to process a dialogue context for the interactive conversation. In this case, the encoder-based model may be further configured to process at least one of intent or sentiment in order to generate the response.

Alternatively or additionally to any of the above, based on the predicted dialogue state, the generated response may include a clarifying question that is not presented with the recommendation slate. Alternatively or additionally to any of the above, based on the predicted dialogue state, the generated response may be selected to steer the interactive conversation back to a prior topic. In this case, the dialogue manager module may include a policy guardrail defining a maximum number of turns permitted during the interactive conversation before steering the interactive conversation back to the prior topic.

Alternatively or additionally to any of the above, the conversational recommender system may further comprise a summary model configured to generate the explanation about the recommendation and to provide the explanation to the dialogue manager module. Alternatively or additionally to any of the above, the recommendation engine may include a ranking module configured to generate the explanation according to item metadata associated with items of the candidate corpus. Alternatively or additionally to any of the above, the dialogue manager module may be configured to predict the dialogue state by evaluation of a user utterance according to stored user information. Here, evaluation of the user utterance may be done according to the large language model based on in-context few-shot learning.

According to another aspect, a computer-implemented method is provided that comprises: receiving, by one or more processors implementing a conversational recommender system, user input via a client device during an interactive conversation; predicting, by the one or more processors, a dialogue state from the received user input according to a trained large language model; generating, by the one or more processors, a response to the received user input based on the predicted dialogue state; identifying, by the one or more processors, a set of relevant items from a candidate corpus; generating, by the one or more processors, a recommendation slate comprising one or more of the relevant items from the set; and presenting the recommendation slate and an explanation about the recommendation slate to a user of the client device along with the response to the received user input.

In one example, the dialogue state is predicted based on the received user input and stored profile information associated with the user. Alternatively or additionally, at least one of predicting the dialogue state or generating the response is performed according to generating a sequence of natural language outputs that encapsulate all context tracking and any intermediate reasoning during the interactive conversation. Alternatively or additionally to any of the above, the large language model may be an encoder-based model configured to generate the response. Here, the encoder-based model includes a first encoder configured to process a target response for the interactive conversation and a second encoder configured to process a dialogue context for the interactive conversation. Alternatively or additionally to any of the above, based on the predicted dialogue state, the generated response may include a clarifying question that is not presented with the recommendation slate. Alternatively or additionally to any of the above, predicting the dialogue state may include evaluating a user utterance according to stored user information.

### BRIEF DESCRIPTION OF THE DRAWINGS

FIGS. 1A-E illustrate an example conversational recommender system and sample interactions in accordance with aspects of the technology.

FIG. 2 illustrates a Transformer-type architecture for use in accordance with aspects of the technology.

FIG. 3A illustrates an exemplary approach to conversational recommendations in accordance with aspects of the technology.

FIG. 3B illustrates an exemplary call flow diagram in accordance with aspects of the technology.

FIG. 4 illustrates an example for operation of a unified LLM dialogue management system in accordance with aspects of the technology.

FIG. 5 illustrates a retrieval framework in accordance with aspects of the technology.

FIG. 6 illustrates a table of example solutions for large-scale retrieval approaches in accordance with aspects of the technology.

FIG. 7 illustrates an encoder-decoder approach in accordance with aspects of the technology.

FIGS. 8A-B illustrates an alternative LLM approach in accordance with aspects of the technology.

FIG. 9 illustrates an alternative unified dialogue manager approach in accordance with aspects of the technology.

FIG. 10 illustrates a generalized dual encoder model in accordance with aspects of the technology.

FIG. 11 illustrates a ranking approach in accordance with aspects of the technology.

FIG. 12 illustrates an approach for user profile interaction in accordance with aspects of the technology.

FIGS. 13A-B illustrate examples of session-based and turn-based control for user simulators in accordance with aspects of the technology.

FIGS. 14A-B illustrate tuning examples in accordance with aspects of the technology.

FIG. 15 illustrates an example method in accordance with aspects of the technology.

### DETAILED DESCRIPTION

The technology comprises a large language model-based conversational recommender system. It supports a multi-modal approach having a slate of recommendations, and an ongoing conversation between a user and an automated conversational agent. Each interaction between the user and the system is referred to as a “turn”. As noted above, each turn may be a user utterance, or system action such as a query or response to an utterance. The system action may include a slate of recommendations, such as presenting a set of videos or other content. Thus, during interaction the user provides a natural language message on their turn, and the automated agent may respond with a natural language message and/or the slate of recommendations based on the conversation.

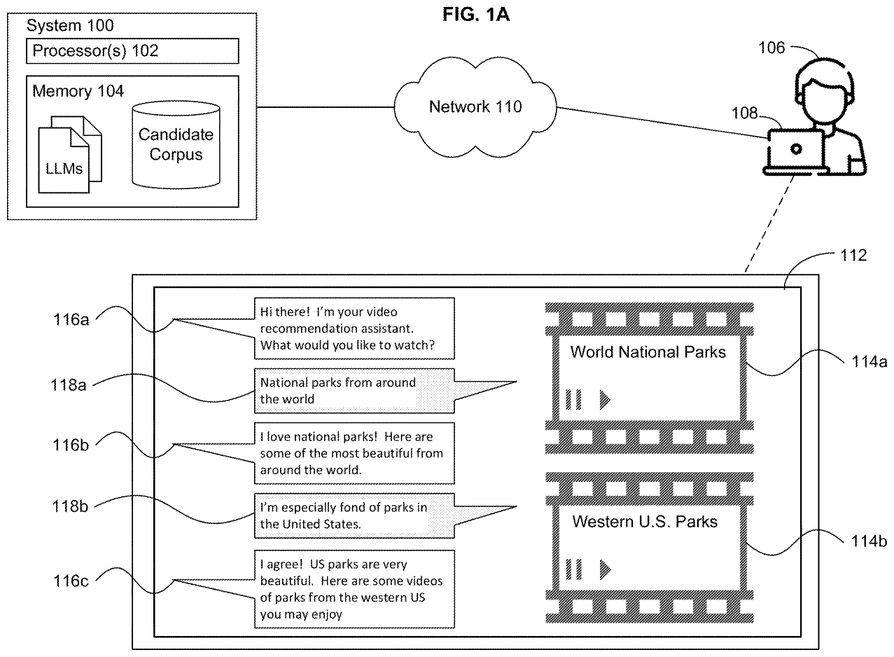

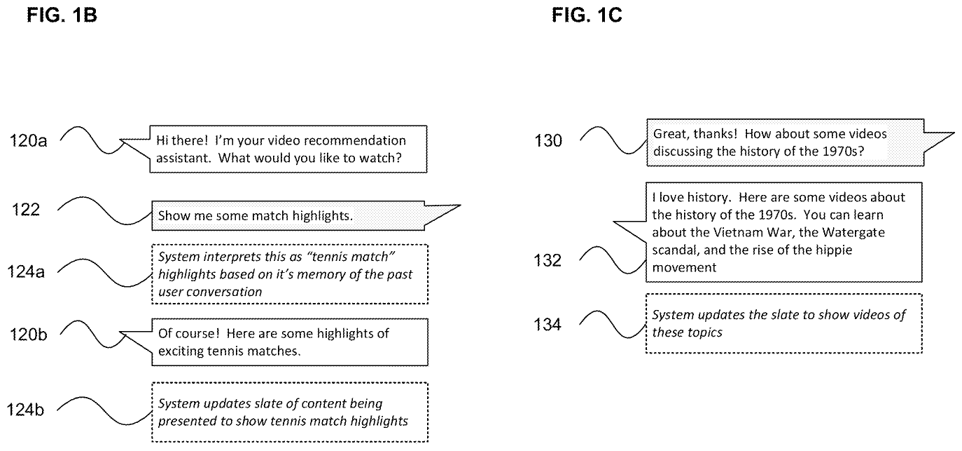

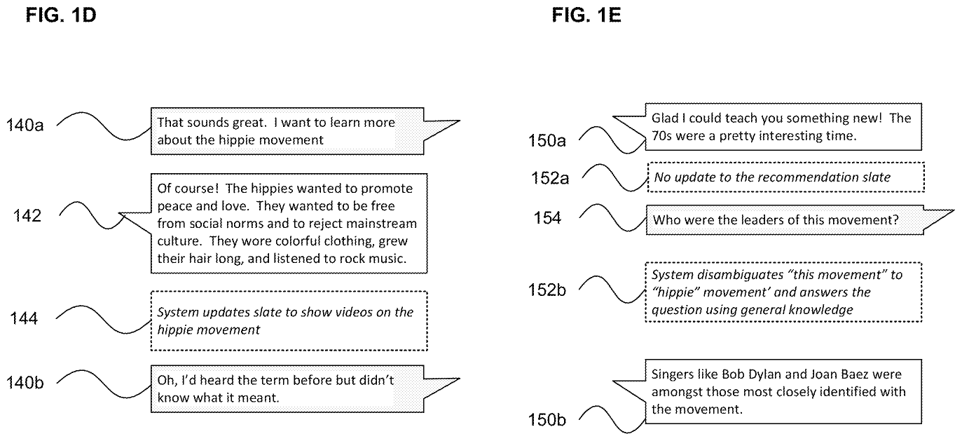

FIG. 1A illustrates an example involving a conversational recommender system 100 for handing user queries and other input, such as for a video app. The system 100 may include one or more processors 102 and memory 104 for storing data. In one example, the memory 104 may store one or more trained LLMs. A user 106 can formulate a query or other comment on their client device 108, which may be, e.g., a laptop or desktop computer, a tablet PC, a mobile phone or PDA, a smartwatch, a smart home appliance, etc. The comment is sent to the system 100 via a network 110. The system applies an LLM to the comment in view of a recommendation corpus, interacting with the user via one or more turns in the conversation in order to select and/or commend certain content. The user input and system commentary may be presented via the app displayable to the user 106 on a graphical user interface (GUI) 112 of the user's client device 110.

For instance, in this example the back and forth between the system and the user helps to refine a set of suggested videos from a first group 114a (here, videos for national parks around the world) to a second group 114b (here, videos for national parks of the western United States). Exemplary dialogue between the system (e.g., 116a, 116b and 116c) and the user (e.g., 118a and 118b) is also illustrated. In this example, the system dialogues 116b and/or 116c may include a recommendation summary for the content being recommended. Each dialogue element 116 or 118 constitutes a turn.

The system may support many conversational use cases. These can include refinement use cases, topic clarification use cases, and contextual reasoning use cases. FIGS. 1B-1E illustrate examples of such use cases. For instance, FIG. 1B involves refinement. Here, the system remembers user preferences over conversations and applies that information to new conversations. In this example, the system communicates to the user initially as shown in system message 120a, asking what the user is interested in watching. The user responds as shown in user message 122 “Show me some match highlights”. Block 124a indicates that the system interprets “match” as being a “tennis match” based on one or more past user conversations. Based on this, system message 120b indicates that highlights of tennis matches are available. Block 124b indicates that the system updates the slate of content being presented in order to show tennis match highlights.

FIG. 1C involves a topic change use case. Now, instead of asking about match highlights, the user message 130 is asking about videos discussing the history of the 1970s. System-driven clarification of this broad topic is performed. For instance, system message 132 identifies several possible topics relating to the 1970s, including the Vietnam War, the Watergate scandal, and the rise of the hippie movement. Block 134 indicates that the system updates the slate in order to show videos of these different topics.

FIG. 1D involves refining recommendations to a more specific topic. For instance, based on the earlier hippie movement dialogue, user message 140a indicates “I want to learn more about the hippie movement”. System message 142 provides details on the hippie movement including the concepts of “promote peace and love” and “be free from social norms and to reject mainstream culture”, also providing information about clothing, hair styles and music preferences. Block 144 indicates that the system updates the slate to show relevant videos on the hippie movement. In response, user message 140b indicates “Oh, I'd heard the term before but didn't know what it meant”.

And FIG. 1E involves a situation where the system recognizes that the user is not requesting any system action, and responds naturally. Thus, following the example from FIG. 1D, here, after receiving user message 140b, a system message 150a is generated that says “Glad I could teach you something new! The 70s were a pretty interesting time”. As shown by block 152a, there is no update to the recommendation slate at this point. But when the next user message 154 is “Who were the leaders of this movement?”, the system disambiguates “this movement” to resolve to the “hippie” movement, and then answers the question using general knowledge, as indicated in block 152b. Here, system message 150b informs the user “Singers like Bob Dylan and Joan Baez were amongst those most closely identified with the movement.”

### Example Systems and Methods

As noted above, one or more LLMs may be employed in the system 100. While there are a number of different possible system configurations, they each incorporate LLMs. According to one aspect, LLMs based on the Transformer architecture may be employed, although other architectures may be used. The arrangements discussed herein can utilize one or more encoders.

In particular, such models excel in the zero or few-shot learning setting, where through appropriately engineered prompts they can be adapted to novel tasks without modifying the model parameters. When more training data is available, parameter efficient tuning methods such as prompt tuning can achieve even better performance while still enabling a single LLM to handle multiple sub tasks. LLMs may also execute multi-step reasoning using chain of thought prompting. The technology described herein shows how to harness the attributes of LLMs within the conversational recommender space, where scarcity of available training data places a high premium on these types of sample efficient learning methods.

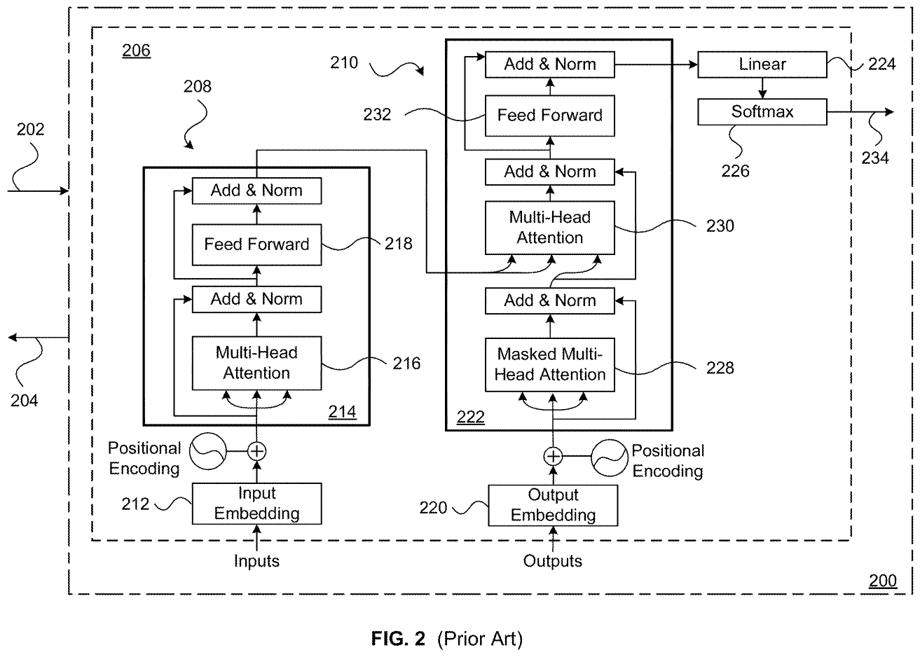

By way of example only, a suitable Transformer architecture is presented in FIG. 2. In particular, system 200 of FIG. 2 is implementable via a computer program by processors of one or more computers in one or more locations. The system 200 receives an input sequence 202 (e.g., a query) and processes the input sequence 202 to transduce the input sequence 202 into an output sequence 204 (e.g., an answer). The input sequence 202 has a respective network input at each of multiple input positions in an input order and the output sequence 204 has a respective network output at each of multiple output positions in an output order.

System 200 can perform any of a variety of tasks that require processing sequential inputs to generate sequential outputs. System 200 includes an attention-based sequence transduction neural network 206, which in turn includes an encoder neural network 208 and a decoder neural network 210. The encoder neural network 208 is configured to receive the input sequence 202 and generate a respective encoded representation of each of the network inputs in the input sequence. An encoded representation is a vector or other ordered collection of numeric values. The decoder neural network 210 is then configured to use the encoded representations of the network inputs to generate the output sequence 204. Generally, both the encoder 208 and the decoder 210 are attention-based. In some cases, neither the encoder nor the decoder includes any convolutional layers or any recurrent layers. The encoder neural network 208 includes an embedding layer (input embedding) 212 and a sequence of one or more encoder subnetworks 214. The encoder neural 208 network may N encoder subnetworks 214.

The embedding layer 212 is configured, for each network input in the input sequence, to map the network input to a numeric representation of the network input in an embedding space, e.g., into a vector in the embedding space. The embedding layer 212 then provides the numeric representations of the network inputs to the first subnetwork in the sequence of encoder subnetworks 214. The embedding layer 212 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence transduction neural network 206. In other cases, the positional embeddings may be fixed and are different for each position.

The combined embedded representation is then used as the numeric representation of the network input. Each of the encoder subnetworks 214 is configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input is the numeric representations generated by the embedding layer 212, and, for each encoder subnetwork other than the first encoder subnetwork in the sequence, the encoder subnetwork input is the encoder subnetwork output of the preceding encoder subnetwork in the sequence.

Each encoder subnetwork 214 includes an encoder self-attention sub-layer 216. The encoder self-attention sub-layer 216 is configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism as shown. In some implementations, each of the encoder subnetworks 214 may also include a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 2.

Some or all of the encoder subnetworks can also include a position-wise feed-forward layer 218 that is configured to operate on each position in the input sequence separately. In particular, for each input position, the feed-forward layer 218 is configured receive an input at the input position and apply a sequence of transformations to the input at the input position to generate an output for the input position. The inputs received by the position-wise feed-forward layer 218 can be the outputs of the layer normalization layer when the residual and layer normalization layers are included or the outputs of the encoder self-attention sub-layer 216 when the residual and layer normalization layers are not included. The transformations applied by the layer 218 will generally be the same for each input position (but different feed-forward layers in different subnetworks may apply different transformations).

In cases where an encoder subnetwork 214 includes a position-wise feed-forward layer 218 as shown, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. As noted above, these two layers are also collectively referred to as an “Add & Norm” operation. The outputs of this layer normalization layer can then be used as the outputs of the encoder subnetwork 214.

Once the encoder neural network 208 has generated the encoded representations, the decoder neural network 210 is configured to generate the output sequence in an auto-regressive manner. That is, the decoder neural network 210 generates the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 210 is auto-regressive, at each generation time step, the decoder network 210 operates on the network outputs that have already been generated before the generation time step, i.e., the network outputs at output positions preceding the corresponding output position in the output order. In some implementations, to ensure this is the case during both inference and training, at each generation time step the decoder neural network 210 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder 210 operate on data at output positions preceding the given output positions (and not on data at any other output positions), it will be understood that this type of conditioning can be effectively implemented using shifting.

The decoder neural network 210 includes an embedding layer (output embedding) 220, a sequence of decoder subnetworks 222, a linear layer 224, and a softmax layer 226. In particular, the decoder neural network can include N decoder subnetworks 222. However, while the example of FIG. 2 shows the encoder 208 and the decoder 210 including the same number of subnetworks, in some cases the encoder 208 and the decoder 210 include different numbers of subnetworks. The embedding layer 220 is configured to, at each generation time step, for each network output at an output position that precedes the current output position in the output order, map the network output to a numeric representation of the network output in the embedding space. The embedding layer 220 then provides the numeric representations of the network outputs to the first subnetwork 222 in the sequence of decoder subnetworks.

In some implementations, the embedding layer 220 is configured to map each network output to an embedded representation of the network output and combine the embedded representation of the network output with a positional embedding of the output position of the network output in the output order to generate a combined embedded representation of the network output. The combined embedded representation is then used as the numeric representation of the network output. The embedding layer 220 generates the combined embedded representation in the same manner as described above with reference to the embedding layer 212.

Each decoder subnetwork 222 is configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right, each network output at a position up to and including the current output position). In particular, each decoder subnetwork 222 includes two different attention sub-layers: a decoder self-attention sub-layer 228 and an encoder-decoder attention sub-layer 230. Each decoder self-attention sub-layer 228 is configured to, at each generation time step, receive an input for each output position preceding the corresponding output position and, for each of the particular output positions, apply an attention mechanism over the inputs at the output positions preceding the corresponding position using one or more queries derived from the input at the particular output position to generate a updated representation for the particular output position. That is, the decoder self-attention sub-layer 228 applies an attention mechanism that is masked so that it does not attend over or otherwise process any data that is not at a position preceding the current output position in the output sequence.

Each encoder-decoder attention sub-layer 230, on the other hand, is configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder-decoder attention sub-layer 230 applies attention over encoded representations while the decoder self-attention sub-layer 228 applies attention over inputs at output positions.

In the example of FIG. 2, the decoder self-attention sub-layer 228 is shown as being before the encoder-decoder attention sub-layer in the processing order within the decoder subnetwork 222. In other examples, however, the decoder self-attention sub-layer 228 may be after the encoder-decoder attention sub-layer 230 in the processing order within the decoder subnetwork 222 or different subnetworks may have different processing orders. In some implementations, each decoder subnetwork 222 includes, after the decoder self-attention sub-layer 228, after the encoder-decoder attention sub-layer 230, or after each of the two sub-layers, a residual connection layer that combines the outputs of the attention sub-layer with the inputs to the attention sub-layer to generate a residual output and a layer normalization layer that applies layer normalization to the residual output. These two layers being inserted after each of the two sub-layers, both referred to as an “Add & Norm” operation.

Some or all of the decoder subnetwork 222 also include a position-wise feed-forward layer 232 that is configured to operate in a similar manner as the position-wise feed-forward layer 218 from the encoder 208. In particular, the layer 232 is configured to, at each generation time step: for each output position preceding the corresponding output position: receive an input at the output position, and apply a sequence of transformations to the input at the output position to generate an output for the output position. The inputs received by the position-wise feed-forward layer 232 can be the outputs of the layer normalization layer (following the last attention sub-layer in the subnetwork 222) when the residual and layer normalization layers are included or the outputs of the last attention sub-layer in the subnetwork 222 when the residual and layer normalization layers are not included. In cases where a decoder subnetwork 222 includes a position-wise feed-forward layer 232, the decoder subnetwork can also include a residual connection layer that combines the outputs of the position-wise feed-forward layer with the inputs to the position-wise feed-forward layer to generate a decoder position-wise residual output and a layer normalization layer that applies layer normalization to the decoder position-wise residual output. These two layers are also collectively referred to as an “Add & Norm” operation. The outputs of this layer normalization layer can then be used as the outputs of the decoder subnetwork 222.

At each generation time step, the linear layer 224 applies a learned linear transformation to the output of the last decoder subnetwork 222 in order to project the output of the last decoder subnetwork 222 into the appropriate space for processing by the softmax layer 226. The softmax layer 226 then applies a softmax function over the outputs of the linear layer 224 to generate the probability distribution (output probabilities) 234 over the possible network outputs at the generation time step. The decoder 210 can then select a network output from the possible network outputs using the probability distribution, to output final result 204.

According to aspects of the technology, variations on the Transformer-type architecture can be used. These may include T5, Bidirectional Encoder Representations from Transformers (BERT), Language Model for Dialogue Applications (LaMDA), and/or Pathways Language Mode (PaLM) type architectures. To enhance system robustness, utterance and context encoders can have additional dense layers to capture information in the embedding space.

### Conversational Recommendation and Dialogue Management

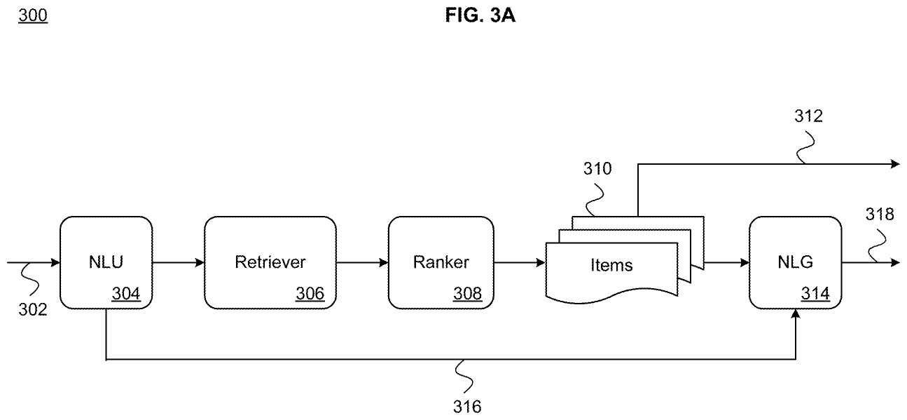

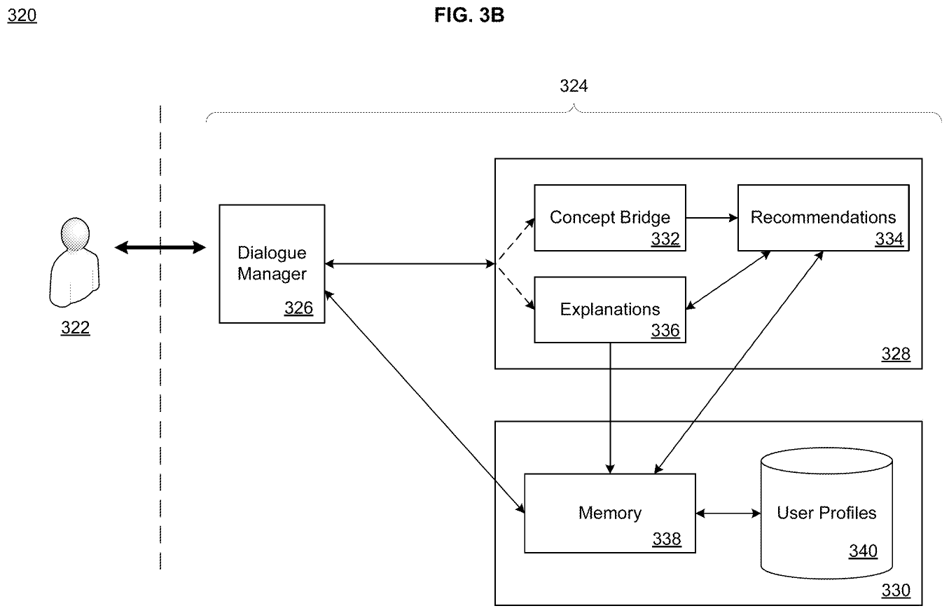

FIG. 3A illustrates an exemplary approach 300 to conversational recommendations. In this example, contextual information 302 is provided to the system, which uses natural language understanding (NLU) at block 304 to identify context based on, e.g., a user query or comment. Once the context is extracted, it is provided to a retriever module 306. The retriever module 306 identifies a subset of candidate items from a corpus, which may be relevant to what the user is interested in. The corpus itself may have thousands, millions or even billions of different items (e.g., videos, music, web pages, etc.). The identified subset of items is passed to a ranker module 308, which decides which of the candidates are to be included in a recommendation slate, and potentially what order they should appear. The result is a curated set of items 310, which is presented to the user as shown by arrow 312. The slate of items is also passed to a natural language generation (NLG) module 314. This module utilizes the context information extracted by the NLU module at block 304 (as shown by arrow 316) to formulate a natural language understanding-based response. This response can be provided to the user along with the recommended slate of items, as shown by arrow 318.

Dialogue management is a central aspect of CRS, acting as the interface between the user and the rest of the system. It is responsible for forming a dialogue policy to guide the user through a multi-turn exploration of the recommendation corpus and generating sensible, interesting, and grounded responses at each turn. Simultaneously, it may either implicitly or explicitly perform dialogue state tracking to extract useful structured representations such as user preferences and intents. This information can be used to inform the dialogue policy and also as the basis for outputting API calls to initiate system actions (e.g. by sending a search query to a recommendation engine backend). From an end-to-end point of view, given context information (dialogue history, a user profile, item summaries, etc.), a primary goal of the dialogue manager is to generate system actions to take, as well as an appropriate system utterance.

There are interesting aspects to dialogue management in the context of conversational recommenders. One of these is a need for control. In contrast to open-ended dialogue, a CRS dialogue manager interacts with the user to achieve the goal of exploring a recommendation corpus. This can entail a mixed-initiative setup where the system responds to user requests and also at times actively steer the conversation in a specific direction. For instance, preference elicitation involves the system determining when and how to best query the user in order to extract maximal information about their preferences.

Another aspect involves ambiguous goals. Despite the system working to control the flow of the conversation, compared to task-oriented dialogue there is may be no clear-cut measure of success for a CRS dialogue manager. Although the system should try to ensure that the conversation does not get too far off track and perhaps rein the user in if they are straying too far from the core recommendation task, the goal is not necessarily to minimize the number of turns that it takes the user to find an acceptable item. Rather, the system aims to provide an overall satisfactory exploratory experience. This can mean that there is never an objectively “correct” thing for the system to say at any given time or an easily defined metric for whether the dialogue manager is doing a good job.

Yet another aspect is grounding in external information. One of the main challenges of a CRS dialogue manager is to faithfully ground its responses to the user in the recommendation corpus. After returning a slate of recommendations, the system should be able to refer to the items in a relevant and factually correct way. Other sources of external information, such as long term preferences coming from a user profile, may also be injected and the dialogue manager should be able to incorporate them appropriately in the ongoing conversation.

FIG. 3B illustrates an example 320 call flow diagram showing how a user 322 interacts with a CRS 324 as discussed herein. The user 322 may be a person or a simulator (e.g., used to train the model(s)). The CRS 324 includes dialogue manager module 326, a recommendation and refinement module 328, and a user-focused module 330. The dialogue manager module 326 interacts with the user 322, e.g., asking questions or providing responses (with or without presenting a slate of curated content) in a multi-turn dialogue. Information based on NLU can be passed to the recommendation and refinement module 328. This module may include a concept bridge sub-module 332, a recommendation sub-module 334 and/or an explanations sub-module 336. The first two sub-modules can be used to obtain recommendations that are provided to the dialogue manager 326, while the third sub-module provides explanations. The concept bridge 332 can extract concepts from a conversation, including one or both of things the user asked to see (positive concepts) or things the user does not want to see (negative concepts). The extracted concepts are used by the recommendations sub-module 334 to retrieve and rank selected recommendations. The explanations sub-module 336 can generate a natural language explanation to accompany the selected recommendations. If the recommendations are ranked, the explanation may indicate why or how they are ranked.

The dialogue manager also interacts with the user-focused module 330, which can include user-related memory 338 and/or a user profile database 340. Memory 338 may be used to track information in a multi-turn conversation. In some instances, the memory 338 may store information from both the current and prior conversations. The user profile database 340 may maintain profile information associated with specific users, including preferences (e.g., I like dogs, or I do not like spiders). The profile information for a given user may be updated based on information derived from interactions with the system. Thus, should the system determine that the user is interested in national parks of the western United States but is not interested in amusement parks, that can be incorporated into the profile information. The profile and conversation-related information of the user-focused module 330 can help tailor the recommendations generated by the recommendations sub-module 334, e.g., by helping to narrow down relevant content and/or exclude irrelevant content.

### LLMs for Conversational Recommendations

According to one aspect of the technology, the system may employ a single unified LLM to execute dialogue management purely in terms of language modeling. One of the distinguishing features of this approach is that there no hardcoded policy graph with fixed dialogue states. Instead, on a given system turn the LLM is configured to generate a sequence of natural language outputs that encapsulate all context tracking, intermediate reasoning, natural language generation, and API calls to the rest of the system. It may be hardcoded that certain string patterns in outputs from the dialogue manager trigger system actions. For instance, an output “Response: <message>” would cause message to be shown as a user facing response, and “Request: <query>” will cause query to be sent to the recommendation engine backend to retrieve a slate of recommendations.

Other outputs of the LLM can function as chain-of-reasoning steps, instructions to itself to follow, or dialogue state tracking inferences. Unlike the system calls, there may be no ingrained rules about the functionality of these intermediate outputs, and conventions about their structure and use must be learned by the LLM either through in-context few-shot learning or tuning. At each turn the LLM takes as input the prior conversation context along with additional information like textual representations of recommendation slates and user profiles that are potentially injected from external sources.

An advantage of this architecture over a modular approach is its simplicity and flexibility. In the modular approach, any new functionality such as the addition of a new user intent or dialogue state may have to be engineered into the system, which is a serious impediment to scalability. The unified LLM architecture shifts the emphasis from engineering-driven to data-driven quality iteration. Thus, to fix a problem or introduce new capabilities, instead of engineering a new component, examples could be generated that enable the LLM to learn the desired behavior. This also creates the potential for the dialogue manager to learn new policy states and useful dialogue state tracking artifacts through the generalization abilities of the LLM.

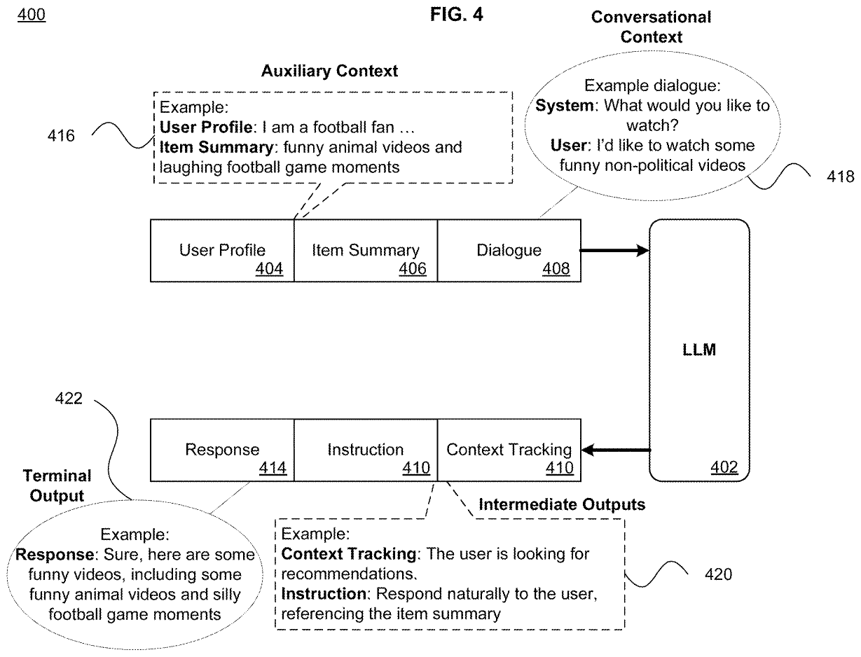

FIG. 4 illustrates an example 400 of how a unified LLM dialogue management system can function. As shown, LLM 402 takes as input the full session context (e.g., user profile 404, item summary 406 and dialogue 408) and outputs a sequence of messages ending in a terminal output that triggers a system action, such as a response to the user. This output includes context tracking 410, instruction(s) 412 and one or more responses 414. As shown in the auxiliary context bubble 416, the user profile information may include that the user is a football fan, while the item summary information includes funny animal videos and laughing football game moments. Bubble 418 provide an example dialogue (conversational context) where in one turn the system asks “What would you like to watch?”, and the user responds with “I'd like to watch some funny non-political videos”. Note that the system may identify that the user does not want to watch political videos, and may add that information to their profile information. The intermediate outputs 420 from the LLM provide context tracking (e.g., the user is looking for recommendations) and an instruction to the dialogue manager (e.g., respond naturally to the user, referencing the item summary). The “terminal output” response 422 to the user may be, e.g., “Sure, here are some funny videos, including some funny animal videos and silly football game moments”.

A challenge to the unified LLM approach is how to effectively control the dialogue manager and guide it towards a reasonable dialogue policy without explicitly constraining it via hard rules. In one implementation, the unified LLM is tuned on a moderate number of manually generated examples. In this way, it is possible to establish some direction about the type of behavior and internal states to be achieved while still relying on the ability of LLMs pretrained on dialogue data to converse naturally with only minimal supervision. Teaching the dialogue manager a more sophisticated policy tailored to the conversational recommender domain may be achieved by tuning the dialogue manager and recommendation modules with larger amounts of synthetically generated data, as discussed below.

### Recommendations and Refinement

Once triggered by the dialogue manager module (e.g., module 326 of FIG. 3B), it is the responsibility of the recommendation module (e.g., module 328 of FIG. 3B) to return a slate of high quality, relevant and diverse recommendations that will be presented to the user. This can either be an initial recommendation slate or a refinement of an earlier slate from the session based on feedback from the user. A traditional recommender system may choose items by inferring preferences of the user from some type of user profile or dense representation built from historical data, possibly taking into account other contextual factors (e.g., the location or time of day). In a search system, the user can supplement these implicit signals with explicit intents, usually through a simple static query. However, a primary challenge of a robust CRS is that the user can express these explicit intents over the course of a full multi-turn conversation, which the recommendation module should understand and connect to the item corpus. A two-stage pipeline can be employed, first retrieving candidate items and then ranking them. This can be done while having the ranker module also jointly generate natural language explanations for why each item is being selected, such as shown at block 336 of FIG. 3B.

A core purpose of the retrieval phase is to take the full corpus, which in the case of videos may contain hundreds of millions of items or more, and based on the context select a small number of candidate items (e.g., 25, 50, 100, 200 or more or less) that will be fed to a downstream ranker (e.g., via recommendations sub-module 334 of FIG. 3B). An important challenge of retrieval is to make this process tractable, as it may not be computationally feasible to process each item independently at inference time.

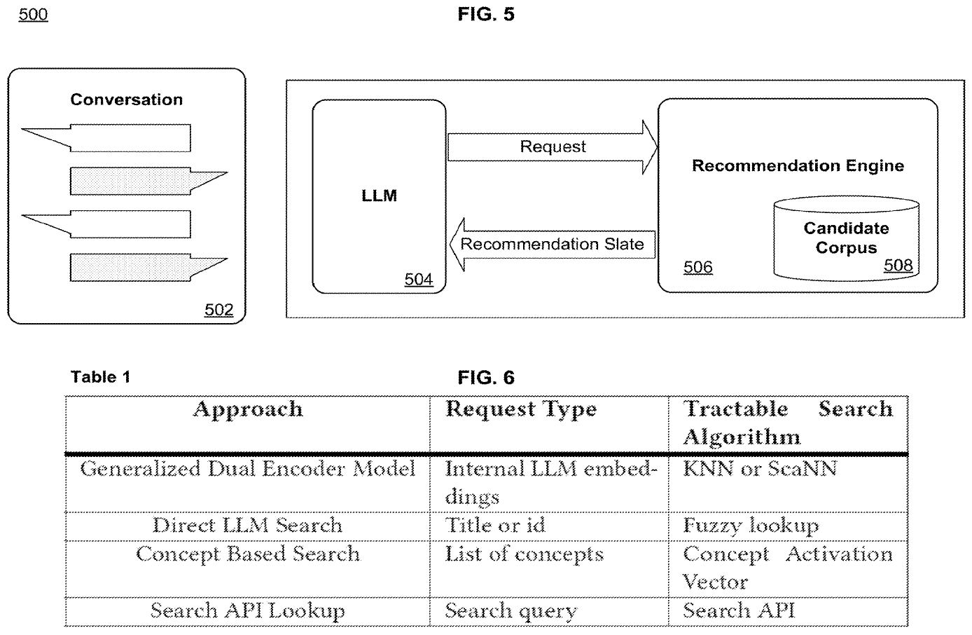

FIG. 5 illustrates a general conceptual framework 500 for retrieval in the problem setting, based on a conversation 502. An LLM 504 that is associated with a dialogue manager processes the session context from the conversation and generates a request, either implicitly through a model activation layer or explicitly through its language output interface. A recommendation engine 506 then uses a tractable search algorithm to retrieve candidates from the item candidate corpus 508, returning a recommendation slate that can then be presented to the user. Table 1 of FIG. 6 provides a few illustrative examples of possible retrieval algorithms that fit into this framework, which we describe in more detail below. Here, K-nearest neighbors (KNN) or Scalable Nearest Neighbors (ScaNN) may be employed for the generalized dual encoder model, such as to handle internal LLM embeddings.

### Example Architectures

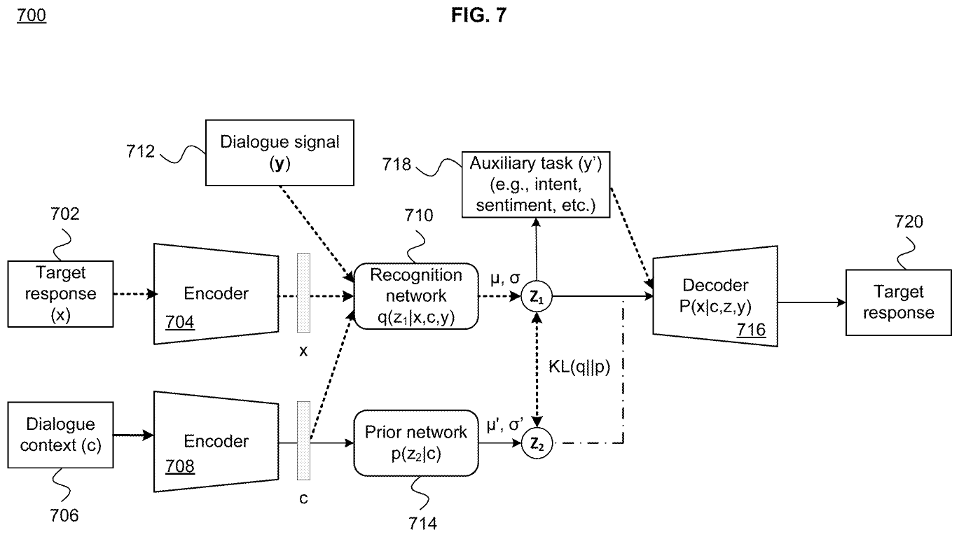

There are a number of different approaches to implement the conceptual framework shown in FIG. 5. One approach 700 is illustrated in FIG. 7 having a dual-encoder architecture, e.g., according to a Conditional Variational Autoencoder (VAE) arrangement. The approach 700 is configured to learn latent distributions of the internal state using an encoder, which can be sampled to generate responses through a decoder. The latent distributions can be thought of as representations of action, intent, interest, sentiment, on-topic/off-topic identifiers. An advantage is that this approach does not need to manually define such classes and instead allows the model to learn from the data. With the learned latent distributions, one can construct a response through sampling of each of the distributions. For example, by choosing the user intent, interest, sentiment, and system action, one may be able to generate a response that can fit in the conversation context. In this approach, an end-to-end dialogue management model is trained to take dialogue context and current turn's items, if they exist, as input, and then output system response. Such responses can be general casual talk if the topic is not recommendation related, or proper response after engaging the recommendation goal.

As shown, a target response (x) at block 702 is provided to a first encoder 704, while a dialogue context (c) at block 706 is provided to a second encoder 708. As shown, the (x) output of the first encoder 704 is passed to a recognition network 710. A dialogue signal (y) at block 712 is also passed to the recognition network 710, along with the (c) output from the second encoder 708. In particular, c represents dialogue context with recommendation items at current turn, if they exist; x represents the utterance at the current turn; and y represents the dialogue state (e.g., intent/query/sentiment, etc.). The recognition network 710 operates on x, c and y, e.g., as a latent variable generative model, where the objective is to infer a latent variable zi for a posterior distribution q given x, c and y. The output of the recognition network 710 is, e.g., μ, σ, which are parameters for the encoder (μ is the mean, and σ is the standard deviation). Similarly, a prior network 714 has a posterior distribution p, which infers latent variable z₂ given c. The latent variables z₁ and z₂ may be employed in a sample and repram technique that enables sampling from a probabilistic distribution that is non-differentiable as part of a neural net architecture and then still backpropogate gradients through this architecture during training. The output of the prior network 714 is, e.g., μ,′ σ′ (here, μ,′ σ′ are predicted versions while μ, σ are the true unknown parameters). The Kullback-Leibler (KL) divergence between q and p is derived, as indicated by the dotted arrow between z₁ and z₂.

The information from z₁ and z₂ is provided to decoder 716, which operates on c, z and y to infer latent variable x. If an auxiliary task (y′) such as intent or sentiment is available at block 718, this information may also be provided to the decoder 716. The output from the decoder 716 is a target response 720. As shown in this figure, the solid arrows indicate paths for training and inference, the dotted arrows indicate paths for training only, and the dash-dot line indicated a path for inference only. In this approach, the model may be an encoder-decoder LLM chosen to convert a dialogue context into a latent space, and then decode the latent representation vector (or a sampled vector from the latent distribution) to generate a system response. The encoders may be, e.g., T5 or BERT-type encoders. For both the utterance encoder 704 and context encoder 708, additional dense layers can be added to capture the difference in embedding space. The recognition network 710 may include a few dense layers, and the prior network 714 may also include a few dense layers. By way of example, the decoder may be a LaMDA-type decoder, and a few dense layers may be used to make predictions on dialogue state for an auxiliary task at block 718.

In one example, the input target response (x) from the system may be “what's your favorite sport?”. The input dialogue context (c) from the system may be “how can I help you?”, and the input user context (c) may be “can you show me sports videos?”. The output target response in this example may be “sure, what's your favorite sport?”

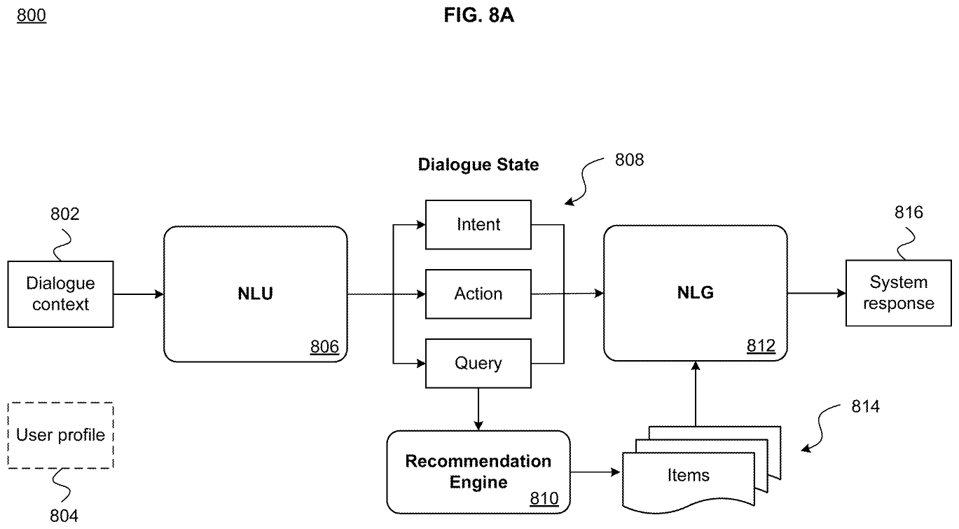

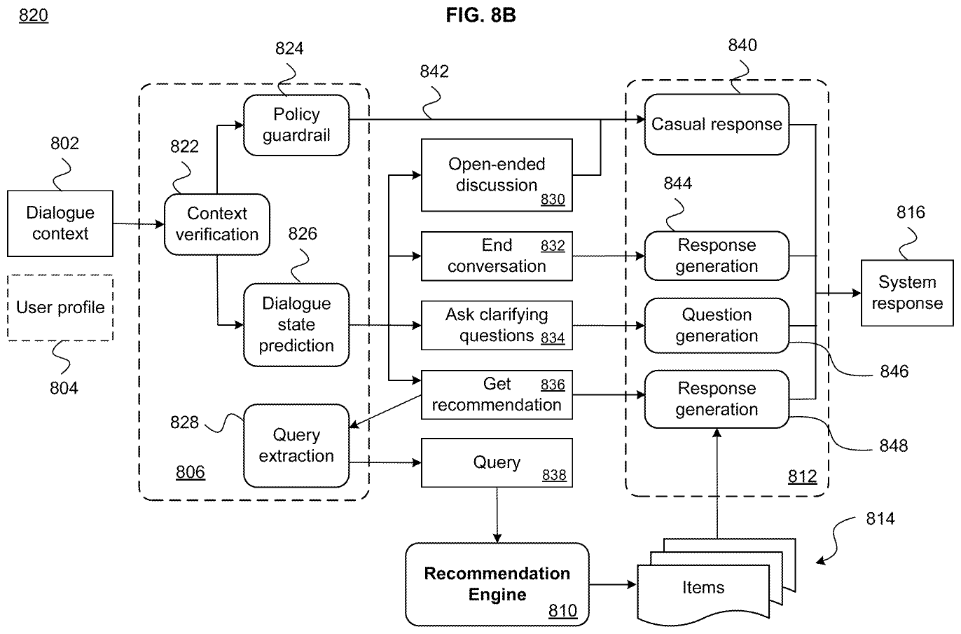

Another approach 800 is illustrated in FIG. 8A. This approach is modular, in which specialized LLM features can be configured to handle different paths of NLU and NLG components. Here, dialogue context 802 and optionally user profile information 804 are input to NLU module 806. The input dialogue context 802 may be the full conversation history up until the current user turn. The output from the NLU module 806 is applied to the dialogue state 808, which may include, e.g., intent, action and query aspects. Information from the dialogue state 808 is provided to recommendation engine 810 and to NLG module 812. The recommendation engine 810 identifies and selects a subset of items 814 to be provided as a slate of suggestions to the user. Information about this subset is provided to the NLG module 812, which uses this and the dialogue state information to generate an appropriate system response 816.

This approach provides dual inputs for the classifier, which avoids the need to train different classifiers after adding new classes. Here, the input includes context and candidate labels, while the output (system response) can be a predicted label.

View 820 of FIG. 8B shows the sub-components for the NLU module 806 and the NLG module 812 in relation to the various dialogue states. Here, the dialogue context 802 (and optionally the user profile information 804) is provided to a context verification module 822. This module includes an LLM classifier, which may be a binary classifier that identifies if the current user turn is relevant to the recommendation context. For user turns that have low score, it indicates that the user utterance is not recommendation related. Here, such out of context information is passed to a policy guardrail module 824 so that casual responses can be generated. In context information is passed to a dialogue state prediction module 826, which is another LLM classifier. The policy guardrail module 824 implements rules to steer the conversation back to a topic after one or more off-topic (chit-chat) turns have occurred. This may take a heuristic approach, e.g., that defines a maximum number (N) of turns that are permitted before appending a steering utterance, such as “Okay, looks like we have gone off topic for a while. Are there any videos you want to watch?”. For turns that are related to the recommendation goal, the dialogue state prediction module 826 predicts what action the system should take.

The NLU module also includes a query extraction module 828, which is an LLM classifier that receives information based on the recommendation dialogue state. The dialogue state prediction module 826 passes its predicted output to the appropriate action or intent dialogue state, which may be one of open-ended discussion 830, end conversation 832, ask clarifying questions 834, or get recommendation 836. As shown, if the state involves getting a recommendation, then that information is passed to the query extraction module 828, which sends the extracted query to a query dialogue state at block 838. As with FIG. 8A, the query information is passed to the recommendation engine 810.

For an open-ended discussion 830, during recommendation, the user could ask questions about some general knowledge (e.g., “Who is the director for the latest superhero movie?”). These questions are treated as in context for the recommendation domain and the system would leverage the trained (e.g., LaMDA) model's knowledge to converse with users on such topics. For end conversation 832, the user has acknowledged the recommendation result (e.g., “Thank you”) but did not continue to search for new videos. In this case, the system should rely properly without engaging in more solicitation questions. For asking clarification questions 834, when the user interest is too broad, or contains multiple interests, the system is configured to ask further clarification questions. It may also make recommendations at the same time. And for get recommendation 836, the user has expressed some specific interest and the system should make recommendations accordingly.

Specific information is passed to various sub-components for the NLG module 812 depending on the dialogue state. Open-ended discussion information is passed to a casual response module 840. As shown, output 842 from the policy guardrail module 824 is also passed to the casual response module 840. Here, a trained (e.g., LaMDA) model is used to generate responses for turns that are not recommendation relevant. The system may remove irrelevant turns from the context. Here, for such non-cooperative turns, which may happen at any given turn of a conversation, the system may remove such turns from context when making predictions for later turns. By preventing the distractions of unrelated turns, the model can make better predictions.

For each system action, a generation model may be developed to form a proper system response. By way of example, when it is the end conversation dialogue state, the information is passed to a first response generation module 844. This module 844 may implement a primed general linear model (GLM) to generate a controlled system response, such as “it was a pleasure helping you find funny animal videos to watch today”. When it is the ask clarifying questions dialogue state, the information is passed to a question generation module 846. And when it is the get recommendation dialogue state, the information is passed to a second response generation module 848. This module also receives the item information generated by the recommendation engine 810. To incorporate the item information in the response, the system can extract an item summary and incorporate the summary with the system response. The summary can be presented as a statement or converted to follow-up questions.

Each of these sub-modules in the NLG module 812 may be trained, e.g., via a LaMDA approach, to generate corresponding dialogue. The outputs from the modules 840, 844, 846 and/or 848 are used by the NLG module 812 to provide an appropriate system response 816.

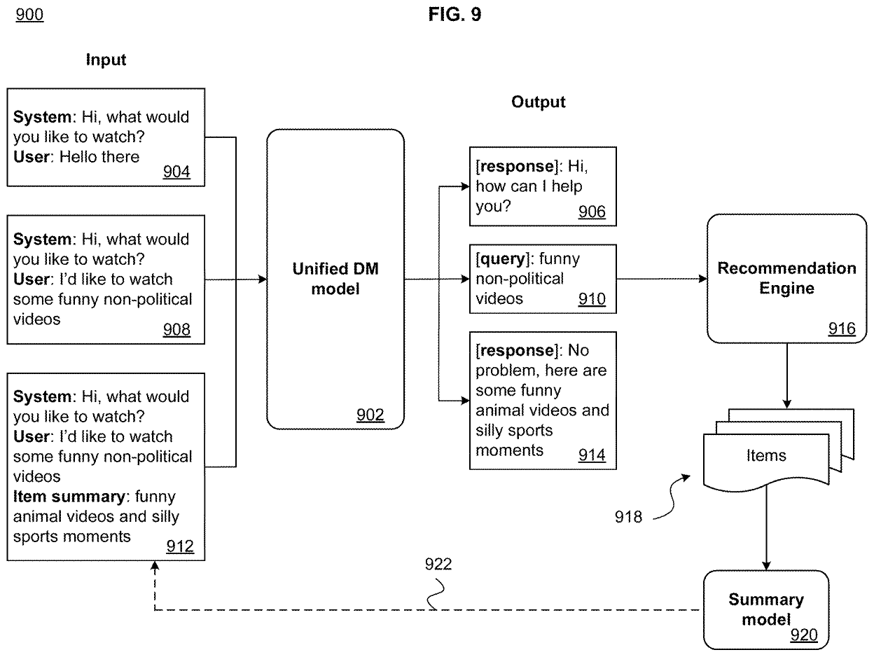

Yet another approach 900 is illustrated in FIG. 9. This architecture provides a unified dialogue manager (DM) system with scalability and flexibility. This single DM takes the input of dialogue history and outputs a response, and a query if it exists. This approach does not define a specific policy based on user intents and instead relies on the model to output responses given the full context. This approach can explore multiple reasoning steps, or even a critic model to select the best response from multiple reasoning paths

As shown in the approach 900, based on the system action to take, there are 3 types of input to output scenarios handled by unified DM model 902. First, at block 904, the input is conversation context, and the corresponding output is a response at block 906. Here, the system action is to respond directly. This scenario happens when the user is in chit-chat mode where no recommendation is returned. Second, at block 908, the input is a conversation context, and the output at block 910 is a query. In this scenario, the system action is to call the recommendation API to find videos or other content, and a corresponding summary. The third scenario has input as a conversation context, plus a content set summary, as shown at block 912. The output is a response as shown at block 914. In this scenario, the system action is to return all the videos or other content together with the response grounded on the content set.

In this approach, the query block 910 calls recommendation engine 916, which selects and optionally ranks items 918. The selected item information is provided to a summary model 920, which generates the item summary that is provided as shown via dashed arrow 922.

### Generalized Dual Encoder Model

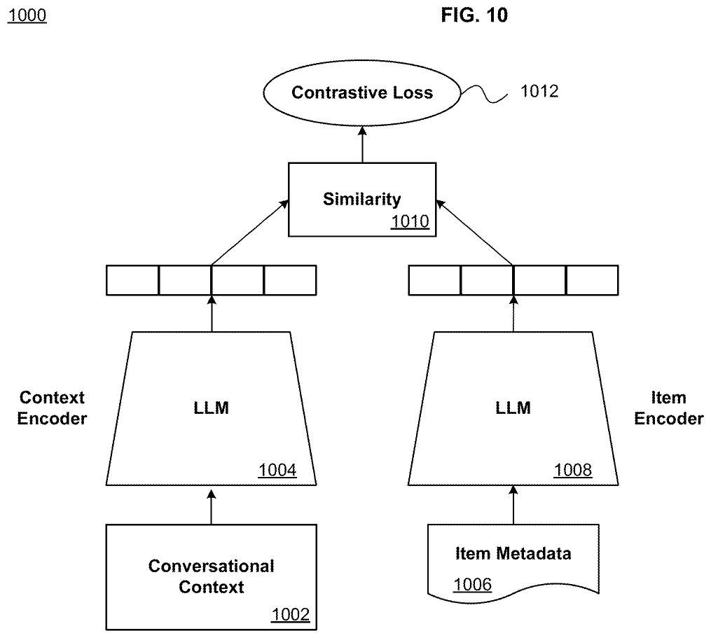

The technology may use a dual encoder model having two neural net towers, one to encode the context and one to encode the items. An example 1000 of this is illustrated in FIG. 10, which illustrates one way for tuning a general dual encoder model. Here, conversational context 1002 is input to a first LLM encoder (context encoder 1004), and item metadata 1006 is input to a second LLM encoder (item encoder 1008). The outputs from each encoder 1004, 1008 are applied to a similarity module 1010, which is used to generate a contrastive loss 1012. The contrastive loss can then be used to train the dual encoder model.

Item embeddings can be generated offline using the item encoder 1008 and stored in an efficient data structure. An approximate nearest neighbor lookup can then use the generated context embedding to perform a sub-linear time retrieval of item embeddings at inference time. This approach can be extended for conversational recommenders by using an LLM as a context encoder that processes the full ongoing conversation between the user and system along with any other additional context information. In this case the request sent to the recommendation engine is an embedding, which can be generated by extracting and then projecting a suitable activation layer from the model.

Dual encoder models trained from scratch may require large amounts of training data to constrain the context tower embeddings to occupy the same subspace as the item tower embeddings. Sometimes it is possible to use pretrained embeddings on the item side (for instance by taking them from an existing production search or recommender system), but still the context embeddings should be tuned to align with the item embeddings to get effective results. LLMs operate via a text-in/text-out interface and much of their power comes from the transfer learning afforded by knowledge gained through extensive pretraining.

Several different search approaches can be employed with the technology discussed herein.

### Direct LLM Search

In a direct LLM search, the LLM directly outputs IDs or titles of items to recommend as text. The tractable search algorithm may be an exact or fuzzy match against items in the corpus, and the recommendation engine may play no role beyond this simple matching. Here, The LLM learns to output these ids/titles through some combination of its pretraining and a corpus-specific fine tuning phase. Here, as a minimal amount of work would be offloaded to the recommendation engine, the LLM would memorize information about the entire item corpus within its model parameters.

### Concept Based Search

In a concept-based search, the LLM outputs a list of concepts, which are then embedded and aggregated by the recommendation engine into a single context embedding. This is used to lookup items through approximate k-nearest neighbor search similar to the generalized dual encoder method. A technique such as Concept Activation Vectors can be used to perform this transformation from concepts to embeddings in the item space. This approach is beneficial because extracting relevant concepts from a conversation is a natural task that can be taught to an LLM through in-context learning or tuning with a small number of examples. Also, because only item embeddings are needed (the concept embeddings are derived from these) if pretrained item embeddings can be borrowed from an existing source then no additional tuning of embeddings is required.

### Search API Lookup

In the search API lookup approach, the LLM directly outputs a search query, which gets fed into a black-box search API to retrieve items. Unlike a concept-based search, which is generic as long as item embeddings can be trained or reused, Search API Lookup is only applicable when such a search API already exists for the domain in question. However, when available, this type of API is often backed by a sophisticated search stack and can yield higher quality results. Analogous to concept based search, in Search API Lookup the LLM can be taught to output relevant search queries using a small number of examples, but the quality of retrieval may be constrained by the extent to which a search query can properly represent the full context of a conversation.

### Ranking and Explanations

After candidate items have been retrieved, a ranking module can be used to decide which of them will be included in the recommendation slate and in what order. Unlike the retrieval module, the ranking module does not perform a tractable search over a large corpus and is therefore less constrained in the types of computation that are possible. One way to do this is with the ranker crossing context and item features (instead of processing them in separate towers as is done in a dual encoder) and potentially using custom ranking losses during training that directly compare candidate items. However, the technology discussed herein is able to take advantage of this extra room for computation to use an LLM that reasons sequentially about how well an item matches the context and generates a rationalization for its decision as a byproduct.

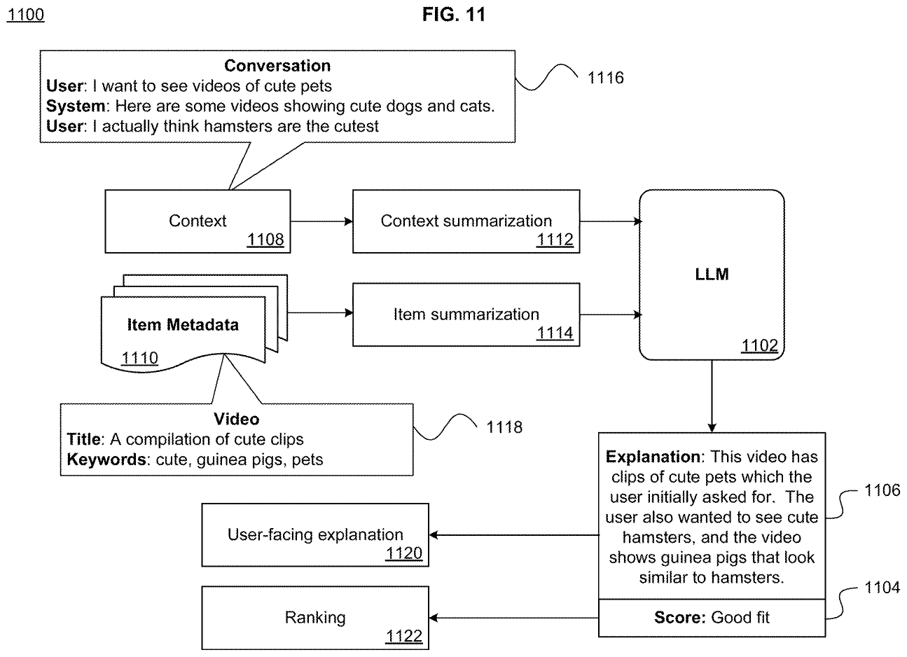

FIG. 11 gives a schematic representation 1100 for an LLM ranking module 1102. For each candidate item, the LLM jointly generates a score (1104) and a natural language explanation for the score (1106). These scores implicitly induce a ranking of the items. There are a number of different solutions for enabling text in/text out LLMs to solve regression problems. Here, one such approach is bucketing the range of possible scores and having the LLM output a semantically meaningful phrase (e.g., “good fit” or “excellent fit”) corresponding to a bucket ID. The output of the process includes an explanation to the user about the slate of content. More particularly, the conversation is used as context for the user's preferences and the metadata is used as context for the item. The LLM takes in summaries of the item side and context side to produce a score for the item and an explanation for the score.

As shown in FIG. 11, context 1108 and item metadata 1110 are summarized in respective context summarization block 1112 and item summarization block 1114. Conversation blurb 1116 shows turn-by-turn interaction between the user and the system regarding what content the user is interest in.

The first step is to create a text summarization of the item that fits into the context window of the LLM based on metadata associated with the item. A summarization example is shown in block 1118. In the case of a video recommender, the metadata includes information such as the title, knowledge graph entities associated with the video, developer description of the video, transcript of the video, and/or user comments. Other metadata could also be utilized. Furthermore, a large multimodal model may be configured to directly process the raw video instead of relying only on textual artifacts. The item summarization can be done offline and may be necessary in the case where the metadata is high volume (e.g., if there are thousands of user comments), since standard LLMs may have a fixed limit on the number of tokens that can be passed in as input and it is wasteful to repeatedly process huge amounts of data associated with an item at inference time. The summarization can be viewed as a special case of the multi-document summarization problem; it is also related to a main challenge of the user profile module, which summarizes large amounts of prior user data into a text format that can be passed into an LLM (or alternatively augment the LLM with the ability to access this information efficiently at inference time). There can also be a similar preprocessing step for summarizing the context information, although this would be done at inference time.

Given the item and context summarizations 1112 and 1114 as input, the LLM ranker 1102 then scores the item, e.g., using chain-of-thought reasoning, which has been shown to improve the performance of LLMs on these types of classification/regression tasks. The intermediate chain-of-thought reasoning steps generated by the LLM function as explanations for why certain items are eventually included or left out of the recommendation slate. These explanations can be viewed internally for debugging purposes and also shown to the user, either by including them as input to the dialogue manager that produces utterances within the conversational interface, or by postprocessing and including them within pop-up boxes in the visual UI where the recommendation slates are displayed. A user-facing explanation 1120, with or without a ranking 1122, can then be provided to the user along with a slate of content.

### User Profile

One key advantage to a CRS is the ability of the user to articulate their preferences over the course of a session, so that the system can assist them without necessarily needing any prior background information Despite this, the personalized experience can be improved if the system has built up a profile of the user beforehand so that there is a mutual starting base to build the conversation on top of. For instance, if a user dislikes jazz music and has shared this previously, they should not have to reiterate this point every new session when searching for music videos.

In traditional deep learning-based recommender systems, nonverbal interaction signals such as clicks or ratings are often used to train embedding representations of a user that can be fed into a neural net. In the present architectures and approaches, the system instead represents users with natural language profiles, which can be consumed by an LLM. These are more transparent compared to embeddings and specific pieces of information can usually be attributed to an original source, which aids in explainability. Also, users can be afforded the option to manually edit these natural language profiles, which gives them greater control to monitor and update their preferences. According to one aspect, user profiles can be built based on a user's repeated interaction with the system over multiple sessions, although it would be possible to incorporate other data sources as well.

One way to represent a user is by a set of salient facts extracted from prior sessions (e.g. “I do not like listening to jazz while in the car”), although many other more sophisticated schemes are possible. Another possibility is to avoid any lossiness by defining a user profile degenerately as the raw conversational history of all sessions the user has had with the system in the past. In this case, one would need to implement an efficient mechanism for an LLM to retrieve relevant facts from this raw history at inference time.

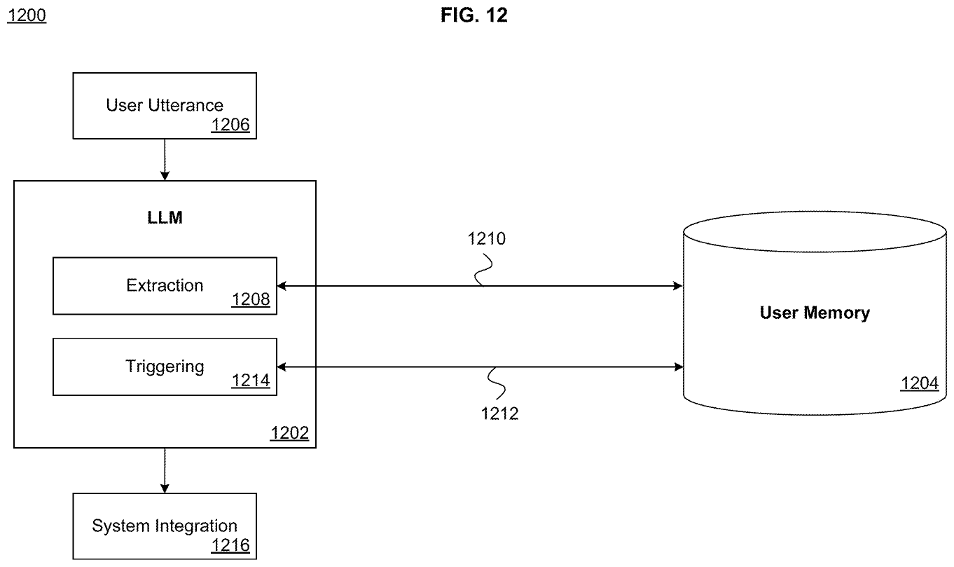

There are three main components for interaction with a user profile module, such as 330 of FIG. 3B. These are memory extraction, triggering and retrieval, and system integration. FIG. 12 illustrates an example 1200 of interaction between an LLM module 1202 and user memory 1204. As shown, a user utterance 1206 is input to the LLM module 1202. Extraction occurs at block 1208, which causes a write instruction 1210 to the user memory 1204. Retrieval 1212 from the user memory 1204 is provided to triggering block 1214, which results in a system integration output at block 1216.

The purpose of the memory extraction component at block 1206 is to identify when a particular utterance contains a meaningful and enduring fact about the user that can be extracted and added to the user profile. This may be implemented by LLM 1202 using in-context few-shot learning as part of the dialogue management module. The triggering and retrieval component at block 1214 decides at what instances during a session it is likely beneficial to query the user profile for supplementary information and to then retrieve the most relevant facts related to the current context. For instance, the LLM may retrieve a single fact from the user profile by embedding the last user utterance and doing a cosine distance comparison between this embedding and precomputed embeddings of each fact in the user profile. More than one fact may alternatively be retrieved. Triggering can be implemented post hoc by thresholding on this minimal cosine distance. Enhanced performance may be possible by using a separate LLM classifier for triggering, retrieving multiple facts from the user profile, and basing retrieval on the entire conversation context of the session as opposed to just the last utterance.

Once the user profile information is retrieved from the user memory 1204, it must be integrated into the rest of the system so that it can influence behavior such as the system's dialogue and API calls to the recommendation engine. How to properly integrate facts coming from a user profile is highly context dependent, for example on how to modulate short term preferences expressed by the user in the current session. For instance, the system may know that the user is allergic to seafood, but if the user explicitly says they want to see some videos about fish recipes to pass along to a friend, then it would be important that the system overrides this preference from the user profile to provide the user what they are asking for. According to one aspect, the system injects facts from the user profile into the text input of the dialogue manager. By doing it enables the LLMs powering the dialogue manager to make nuanced decisions about how to utilize this auxiliary information in the context of the ongoing session without having to engineer any hard rules into the system.

### Simulation and Large-Scale Tuning

A major impediment to building a high-quality industrial CRS is a lack of data available for training and evaluation. Large-scale recommender systems may be trained on user interaction data mined from the logs of existing products; however, conversational recommenders are a nascent technology in many respects and thus products using this paradigm may not exist or be widely utilized. The instant technology is able to solve the data sparsity problem by exploiting the transfer learning ability of large language models using in-context few-shot learning or fine-tuning on a small number of manually generated examples.

According to the conversational recommender setup considered herein, a session has sequence S={s₁, u₁, s₂, u₂, . . . , sₙ, uₙ}, where each uᵢ is a natural language utterance by the user and each sᵢ is a combination of a natural language utterance and possibly a slate of recommendations by the CRS. Therefore, a user simulator is defined by a function f(S)=Uᵢ, where S={s₁, u₁, s₂, u₂, . . . , sᵢ} is a partial session and Uᵢ is a distribution over possible user utterances uᵢ continuing the session. Given a fixed CRS and such a user simulator f, one can generate a new sample session by having the CRS and f interact for a given number of turns (the CRS generates each si and f generates each uᵢ).

A desirable property for the user simulator to have when synthetically generating data for evaluation or training is realism. In particular, conversations between the user simulator and CRS should be nearly indistinguishable from conversations between a representative group of real users and the CRS. Let R be a set of sessions generated by having real users interact with a particular CRS, and Q be a set of simulated sessions sampled from the CRS and a user simulator f according to the procedure outlined above. Three ways are provided to measure the realism of f. One is to have crowdsource workers attempt to distinguish between simulated sessions coming from Q and real sessions coming from R. A second is to train a discriminator model on the same differentiation task. And the third is to let g(S)→[1, k] be a function that classifies a session into k categories and let G={gᵢ} be an ensemble of such classifiers. Here, one way to define such an ensemble is by adapting dialogue state tracking artifacts used within the dialogue management module of a CRS. For instance, one can have a classifier that labels the user intent at a specific turn, or the topics that are covered within a session, or the primary sentiment of a session. Once defined, one can measure how close the distributions Q and R are by matching statistics according to the classifier ensemble G.

A necessary condition of realism is diversity: Simulated sessions from Q should have sufficient variation to invoke all the different functionality of a CRS users will encounter in practice when using the system. It may be that in certain situations measuring realism directly is difficult, for instance if collecting a representative set of real user sessions is infeasible. In this case we can at least attempt to measure the diversity of the user simulator, for instance by defining a notion of entropy of Q with respect to the classifier ensemble G.

### Controlled Simulation

One starting point for building a user simulator is the observation that an unconstrained LLM built for dialogue such as LaMDA can do a reasonable job at impersonating real users. The LLM takes as input the full history of the ongoing conversation and outputs the next user utterance, similar to how a CRS dialogue manager can use an LLM to generate system utterances. However, it is desirable to exhibit greater control over the simulator to increase its realism. In controlled simulation, the user simulator is conditioned on additional latent (to the CRS) variables that allow for guiding its behavior in a certain direction.

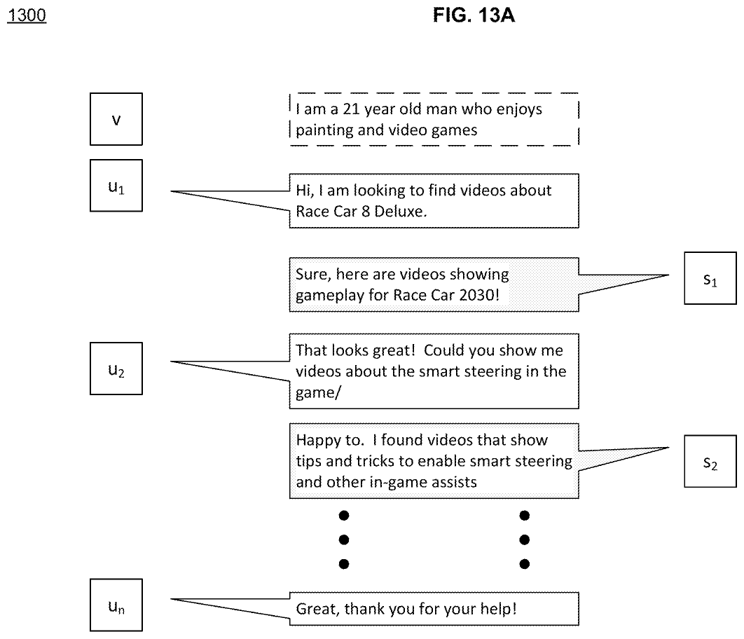

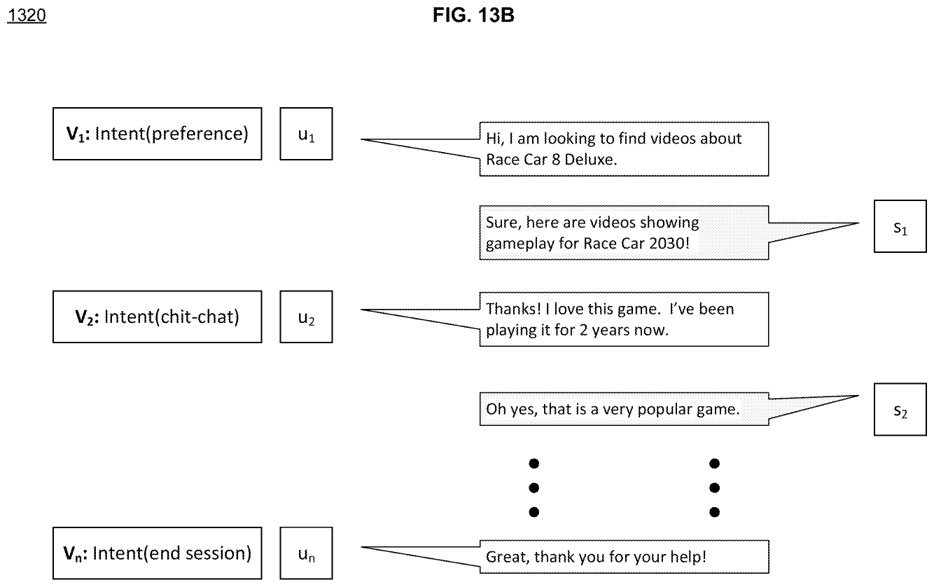

Two different variations have been explored: session-level control and turn-level control. In session-level control, a single variable v is defined at the beginning of the session and is used to condition the user simulator throughout the session. For instance, one could define v as a user profile such as the ones discussed above. FIG. 13A provides an example 1300 of session-based control. Here, a single variable, such as a user profile (v) is used to condition a user simulator. For turn-level control, a distinct variable vi is defined at each turn of the session and is used to condition the simulator for that turn. For instance, once could define each vi to be a user intent for the simulator to adopt at that turn. FIG. 13B provides an example of turn-level control, showing the simulated user intent at each turn.

In the case of an LLM user simulator, one way to execute the control is to translate the variable into text that can be included as part of the simulator's input along with the rest of the conversation. For instance, for the user profile example one could append the “I am a 21 year old man who enjoys painting and video games” to the beginning of the conversation to induce the LLM to imitate this personality, as shown in FIG. 13A. To increase realism, one possible strategy is to define session-level or turn-level variables in terms of the classifiers making up one of the ensembles G discussed above and then to sample the variables according to the empirical distribution of the collection of real user sessions R. Another possibility is to ground the conditioning in trajectories coming from real data from a related product. For instance, for a video conversational recommender, one could look at query sequences submitted by users in their searches and sample turn-level variables as trajectories of topics that match these query sequences.

### Generating Synthetic Training Data

To use a user simulator to generate data for supervised training of one of the CRS system modules an additional property may be needed: ground truth labels that the system can learn from. As one example, suppose the system is trying to learn a sentiment classifier as part of a traditional dialogue state tracking module. For this one would need to generate a set of examples Sᵢ, lᵢ, where Sᵢ is a session s₁, u₁, s₂, u₂, . . . sₙ, uₙ and lᵢ is a ground truth label for the primary user sentiment within Si coming from a set of possible labels L, e.g., {angry, satisfied, confused, . . . }. One can use controlled user simulation to solve this problem, by defining a session level variable v over this set of labels L. First a variable v is sampled from L (e.g., “angry”) and then condition the simulator based on this label, for instance in a priming implementation by appending the message “You are an angry user” to the beginning of the input of the simulator. If this LLM control problem is solved effectively, then one can attach a label li =“angry” to the session Si and trust that with high probability it will be accurate.

A more ambitious use case is generating data for training the retrieval and ranking modules discussed above. For this once can define a session level variable v as a tuple (x, j), where x is an item from the corpus and j is an integer turn index. Once v=(x, j) is sampled, the simulator is conditioned to generate a session S={v, s₁, u₁, s₂, u₂, . . . , sⱼ, uⱼ, . . . } such that after j turns the item x is a good match for the context S (the user would be satisfied if on turn s j+1 the system included x within a recommendation slate). This session can then be used as an input example for training a recommendation module, where the item x is a positive instance and other items from the corpus can be sampled as negatives. This is a far more complex conditioning problem, and a simple zero-shot priming instruction (e.g., “Generate a session such that after j turns item x is a good match for the context”) may not be suitable.

### Tuning System Models

Another aspect of the technology involves the option of tuning LLMs using large amounts of synthetically generated data. Tuning for three modules discussed above: retrieval, ranking/explanation, and dialogue management, is now addressed. It is noted that FIG. 10A referenced above illustrates tuning for a general dual encoder retrieval model. For retrieval it may be assumed that the training examples are tuples of the form (S, xₚₒₛ, {x_{neg}}, where S′ is a partial session s₁, u₁, s₂, u₂, . . . sᵢ, uᵢ. xₚₒₛ is an item that is a good match for the context S′ (in the sense defined previously). And {x_{neg}} is a set of negative items generated by some negative sampling procedure. Given this data, one can tune a Generalized Dual Encoder Model (see FIG. 10A), in which the initial context representation and item representations are each encoded by an LLM. Regardless of whether only the adapter layers of the two tower model are tuned, or the LLM params as well, the loss is fully differentiable and normal supervised learning with gradient descent suffices.

Retrieval may be implemented using Search API Lookup as discussed above. In this scheme an LLM processes the session history and outputs a search query, which then gets passed into a black-box search algorithm. If one chooses to keep this architecture the loss is no longer differentiable and ordinary supervised learning is not possible. Instead, one can reframe the setup as a contextual bandit problem, where the LLM is a policy, the labels are rewards signals, and the black box search algorithm is treated as the environment. If the LLM encoder is shared with other modules, there is a choice of tuning protected parameters of the LLM that influence only this task of outputting a search query, or instead tuning shared parameters of the LLM that also influence the behavior of these other modules.

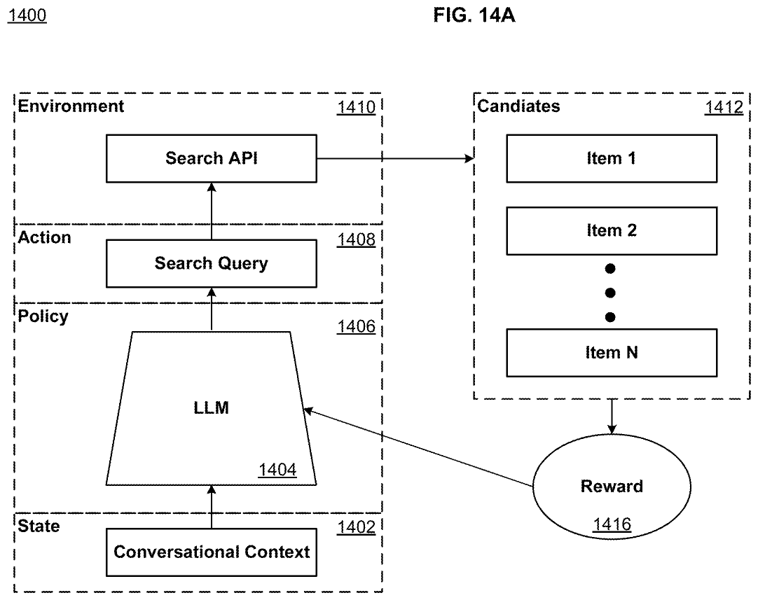

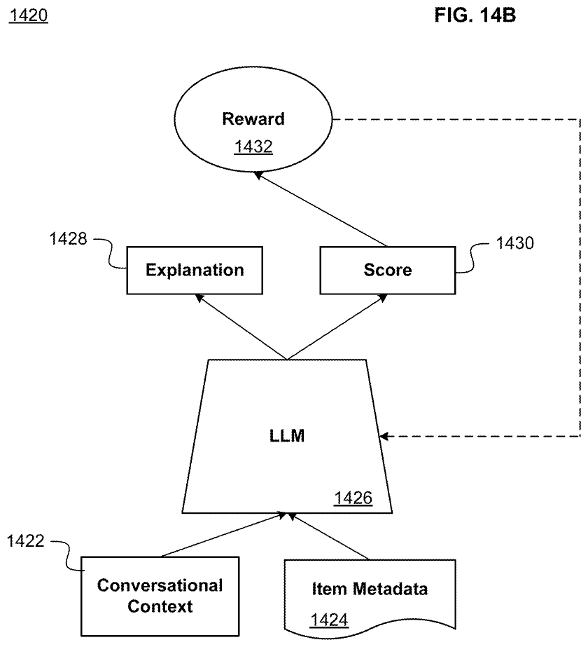

FIG. 14A illustrates an example 1400 for tuning a search API lookup retrieval model. Here, conversational context is part of state block 1402. LLM retrieval model 1404 is part of the policy block 1406, and receives state-based input from the conversational context. The output of the retrieval model 1404 is provided to the search query in block 1408, which issues instructions to the search API in environment block 1410. The information from the search API is used to identify suitable items from candidate corpus 1412. The output here, signals at reward block 1414, are fed back to the retrieval model 1404 to update it.

For ranking, assume the training examples are tuples of the form (S′, Y), where S′ is a partial session s₁, u₁, s₂, u₂, . . . , sᵢ such that sᵢ contains a recommendation slate and Y is a list of relevancy scores for the items in that slate. An LLM-based ranking module was introduced above that jointly generates a score for each item and an explanation for that score. Using this data, one can tune the ranking LLM to predict the ground truth labels as a regression problem. Using only this relevancy data one may not directly tune the LLM to generate better explanations, although this is still possible using bootstrapping methods that depend only on labels for the end task (in this case the scoring task). FIG. 14B illustrates an example 1420 of tuning a joint ranking/explanation model. Here, the only learning signal comes from ground truth scores. As shown, conversational context 1422 and item metadata 1424 are fed into the LLM 1426. The model generates an explanation 1428 and a score 1430. The score 1430 is used to obtain a signal at reward block 1432, which is fed back to the model 1426 to update it.

### Tuning for Dialogue Management

According to one aspect of the technology, the system may tune the LLM on a moderate (e.g. O(1000)) number of example sequences meant to demonstrate desired behavior. The following is a strategy for building on this medium-scale tuning. First, generate a set of simulated sessions Q using a user simulator as outlined above. Second, use crowdsourcing to evaluate the unified LLM by rating per turn responses within Q in terms of fluency, interestingness, groundedness, etc., as well as giving session level ratings based on overall how effective the system was at helping the user explore the recommendations corpus. Third, train reward models on this rating data (which may also use LLMs with chain-of-thought reasoning). And fourth, further tune the unified LLM on simulated sessions through reinforcement learning to optimize for proxy rewards generated by these reward models.

As noted above, aspects of the technology involve evaluating user interactions with an automated conversational recommender system. This can include evaluating each user turn in a dialogue, as well as employ a user-focused module that can be curated with profile information for one or more users. Such users can be afforded the option to their profiles, which provides enhanced control to monitor and update their preferences. Thus, a user may be provided with controls allowing the user to make an election as to both if and when systems, programs, or features described herein may enable collection of user information (e.g., information about a user's actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used and maintained, and what information is provided to the user.

The different aspects of the conversational recommend system discussed herein afford a number of technical benefits via the use of a large language model that can function as part of a dialogue manager. The CRS may keep conversations on track (e.g., identifying and addressing recommendation-irrelevant utterances) and quickly and effectively serve a slate of relevant recommendations to the user. An explanation may accompany the recommendations, so that the user understands what criteria were used to select the content. The system is flexible and may be implemented using a variety of LLM architectures. The system also gives users controllability in which they may refine their interests through multi-turn conversations. Users may also access and manage their profiles or other preferences. The technology is applicable to a wide variety of use cases, including video, audio or website recommendations.

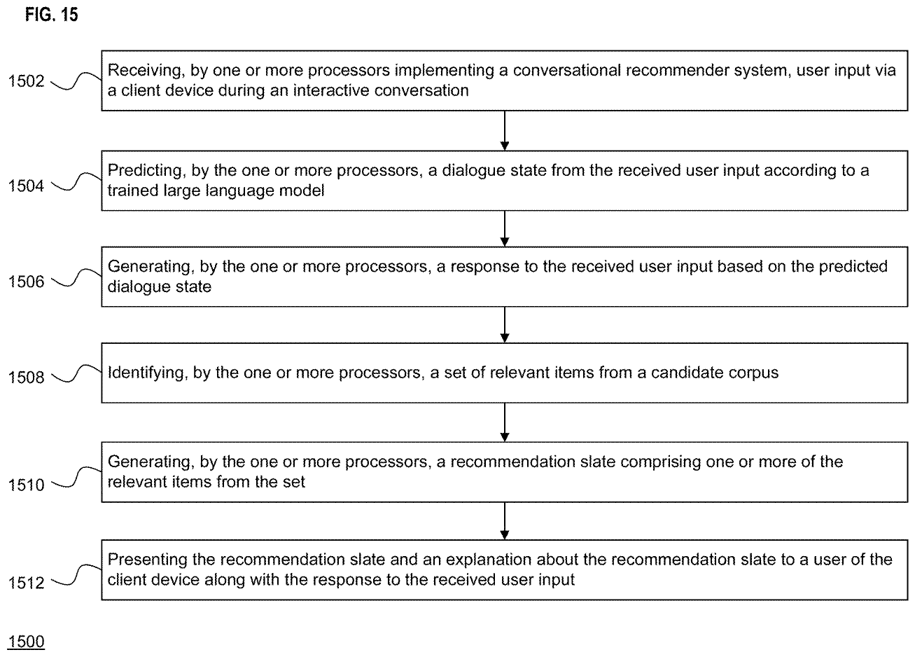

FIG. 15 illustrates a method 1500 in accordance with the above discussion. The method includes, at block 1502, receiving, by one or more processors implementing a conversational recommender system, user input via a client device during an interactive conversation. At block 1504 the method includes predicting, by the one or more processors, a dialogue state from the received user input according to a trained large language model. At block 1506 the method includes generating, by the one or more processors, a response to the received user input based on the predicted dialogue state. At block 1508, the method includes identifying, by the one or more processors, a set of relevant items from a candidate corpus. At block 1510 the method includes generating, by the one or more processors, a recommendation slate comprising one or more of the relevant items from the set. And t block 1512, the method includes presenting the recommendation slate and an explanation about the recommendation slate to a user of the client device along with the response to the received user input.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A conversational recommender system implemented by one or more processors of a computer system, the conversational recommender system comprising:
a dialogue manager module having a trained large language model, the dialogue manager being configured to:
receive user input via a client device during an interactive conversation;
predict a dialogue state from the received user input according to the trained large language model; and
generate a response to the received user input based on the predicted dialogue state; and
a recommendation engine in operative communication with the dialogue manager, the recommendation engine being configured to:
receive a query from the dialogue manager according to the predicted dialogue state;
identify a set of relevant items from a candidate corpus; and
generate a recommendation slate comprising one or more of the relevant items from the set;
wherein the dialogue manager is further configured to present the recommendation slate and an explanation about the recommendation slate to a user of the client device along with the response to the received user input.

2. The conversational recommender system of claim 1, wherein the dialogue manager module is configured to predict the dialogue state based on the received user input and stored profile information associated with the user.

3. The conversational recommender system of claim 2, wherein the stored profile information is updatable by the conversational recommender system according to information provided by the user during the interactive conversation.

4. The conversational recommender system of claim 3, wherein the stored profile information is editable by the user.

5. The conversational recommender system of claim 1, wherein the dialogue manager module is configured to either predict the dialogue state or generate the response according to generation of a sequence of natural language outputs that encapsulate all context tracking and any intermediate reasoning during the interactive conversation.

6. The conversational recommender system of claim 1, wherein the large language model is an encoder-based model configured to generate the response.

7. The conversational recommender system of claim 6, wherein the encoder-based model includes a first encoder configured to process a target response for the interactive conversation and a second encoder configured to process a dialogue context for the interactive conversation.

8. The conversational recommender system of claim 7, wherein the encoder-based model is further configured to process at least one of intent or sentiment in order to generate the response.

9. The conversational recommender system of claim 1, wherein, based on the predicted dialogue state, the generated response includes a clarifying question that is not presented with the recommendation slate.

10. The conversational recommender system of claim 1, wherein, based on the predicted dialogue state, the generated response is selected to steer the interactive conversation back to a prior topic.

11. The conversational recommender system of claim 10, wherein the dialogue manager module includes a policy guardrail defining a maximum number of turns permitted during the interactive conversation before steering the interactive conversation back to the prior topic.

12. The conversational recommender system of claim 1, further comprising a summary model configured to generate the explanation about the recommendation and to provide the explanation to the dialogue manager module.

13. The conversational recommender system of claim 1, wherein the recommendation engine includes a ranking module configured to generate the explanation according to item metadata associated with items of the candidate corpus.

14. The conversational recommender system of claim 1, wherein the dialogue manager module is configured to predict the dialogue state by evaluation of a user utterance according to stored user information.

15. The conversational recommender system of claim 14, wherein evaluation of the user utterance is done according to the large language model based on in-context few-shot learning.

16. A computer-implemented method comprising:
receiving, by one or more processors implementing a conversational recommender system, user input via a client device during an interactive conversation;
predicting, by the one or more processors, a dialogue state from the received user input according to a trained large language model;
generating, by the one or more processors, a response to the received user input based on the predicted dialogue state;
identifying, by the one or more processors, a set of relevant items from a candidate corpus;
generating, by the one or more processors, a recommendation slate comprising one or more of the relevant items from the set; and
presenting the recommendation slate and an explanation about the recommendation slate to a user of the client device along with the response to the received user input.

17. The method of claim 16, wherein the dialogue state is predicted based on the received user input and stored profile information associated with the user.

18. The method of claim 16, wherein at least one of predicting the dialogue state or generating the response is performed according to generating a sequence of natural language outputs that encapsulate all context tracking and any intermediate reasoning during the interactive conversation.

19. The method of claim 16, wherein the large language model is an encoder-based model configured to generate the response, and the encoder-based model includes a first encoder configured to process a target response for the interactive conversation and a second encoder configured to process a dialogue context for the interactive conversation.

20. The method of claim 16, wherein, based on the predicted dialogue state, the generated response includes a clarifying question that is not presented with the recommendation slate.

21. The method of claim 16, wherein predicting the dialogue state includes evaluating a user utterance according to stored user information.
